(19) United States
(12) Patent Application Publication
(10) Pub. No.: US 2015/0310568 A1
(43) Pub. Date: Oct. 29, 2015

(54) SOCIAL NETWORKING METHOD AND SYSTEM FOR INCENTIVIZING BEHAVIOR

(71) Applicant: HeroWatcher, Inc., Huntington Park, CA (US)

(72) Inventor: Safa Sadeghpour, Huntington Park, CA (US)

(21) Appl. No.: 14/673,402

(22) Filed: Mar. 30, 2015

Related U.S. Application Data
(60) Provisional application No. 61/972,976, filed on Mar. 31, 2014.
(60) Provisional application No. 62/120,321, filed on Feb. 24, 2015.

(51) Int. Cl. G06Q 50/00; G06Q 30/02

(52) U.S. Cl. CPC G06Q 50/01; G06Q 30/0217

(57) ABSTRACT

Provided herein are computer implemented methods and social networking systems for rewarding an act that merits an award. Certain implementations of the subject method includes i) providing an award sender with a user interface on a computer system which allows the award sender to select an award recipient, ii) providing the award sender with an option to create an award and/or select from a preexisting award template using the user interface, wherein the award comprises an award category, iii) sending an award sender-created award and/or award sender-selected award to the award recipient based on the award sender's selection of the award recipient for having performed an act that merits an award, and iv) posting content regarding the award received by the recipient on a communally accessible (e.g., public) online platform.

### CROSS-REFERENCE TO RELATED APPLICATIONS

This application claims the benefit of U.S. Provisional Patent Application Nos. 61/972,976, filed Mar. 31, 2014 and 62/120,321, filed Feb. 24, 2015, which applications are incorporated herein by reference in their entireties.

### BACKGROUND

Monetary wealth, physical attractiveness and personal achievement are highly valued and rewarded in society. Such values form the basis of traditional social ladders that operate in society and the rewards incentivize behaviors that promote creation of wealth, attainment of physical attractiveness and personal achievements. These social ladders share some common characteristics that help to inspire individuals to pursue their goals. Social ladders are hierarchical, having measureable positions on the ladder, where a higher position on the ladder translates into greater social validation. Assets that determine one's position on the hierarchy or that are obtained as result of one's position on the hierarchy are often exchangeable. Thus, ranking highly on social ladder affords one with the ability to exchange what one has for social validation and recognition. For instance, monetary wealth, physical attractiveness and remarkable personal achievement all can grant access to scarce resources.

### SUMMARY

Provided herein are computer implemented methods and social networking systems for rewarding an act that merits an award. An implementation of the subject method includes i) providing an award sender with a user interface on a computer system which allows the award sender to select an award recipient, ii) providing the award sender with an option to create an award and/or select from a preexisting award template using the user interface, wherein the award comprises an award category, iii) sending an award sender-created award and/or award sender-selected award to the award recipient based on the award sender's selection of the award recipient for having performed an act that merits an award, and iv) posting content regarding the award received by the recipient on a communally accessible (e.g., public) online platform.

### BRIEF DESCRIPTION OF THE FIGURES

The skilled artisan will understand that the drawings, described below, are for illustration purposes only. The drawings are not intended to limit the scope of the present teachings in any way.

FIG. 1 shows an award creation user interface that allows an award sender to select an award recipient, according to an embodiment of the present disclosure. Award category and third-party logo shown are exemplary and not limiting.

FIG. 2 shows an award creation user interface after the award sender selects an award recipient, according to an embodiment of the present disclosure. Names, award category and third-party logo shown are exemplary and not limiting.

FIG. 3 shows an award creation user interface with a second style, after the award sender selects an award recipient, according to an embodiment of the present disclosure. Names, award category and third-party logo shown are exemplary and not limiting.

FIG. 4 shows an award creation user interface that allows an award sender to select an award category and dedication text, according to an embodiment of the present disclosure. Award category and dedication text shown are exemplary and not limiting.

FIG. 5 shows another award creation user interface that allows an award sender to select an award category and dedication text, according to an embodiment of the present disclosure. Award category and dedication text shown are exemplary and not limiting.

FIG. 6 shows an award creation user interface that allows an award sender to select a funding (e.g., donation) recipient, according to an embodiment of the present disclosure. Funding recipients shown are exemplary and not limiting.

FIG. 7 is a user interface showing an award sent by an award sender, according to an embodiment of the present disclosure. Names, award category, dedication text, and third-party links shown are exemplary and not limiting.

FIG. 8 is a user interface showing a user profile, according to an embodiment of the present disclosure. Names, award category, and third-party links shown are exemplary and not limiting.

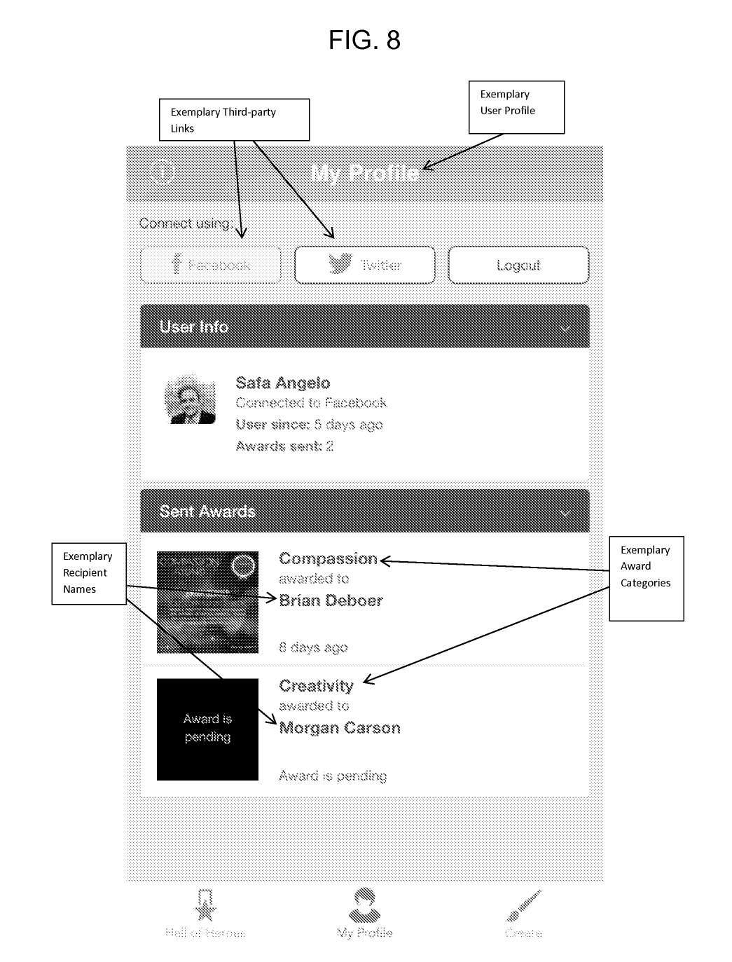

FIG. 9 is a user interface showing a roster board of rewarded users, according to an embodiment of the present disclosure. Names, award category, dedication text, funding recipient link and third-party logos shown are exemplary and not limiting.

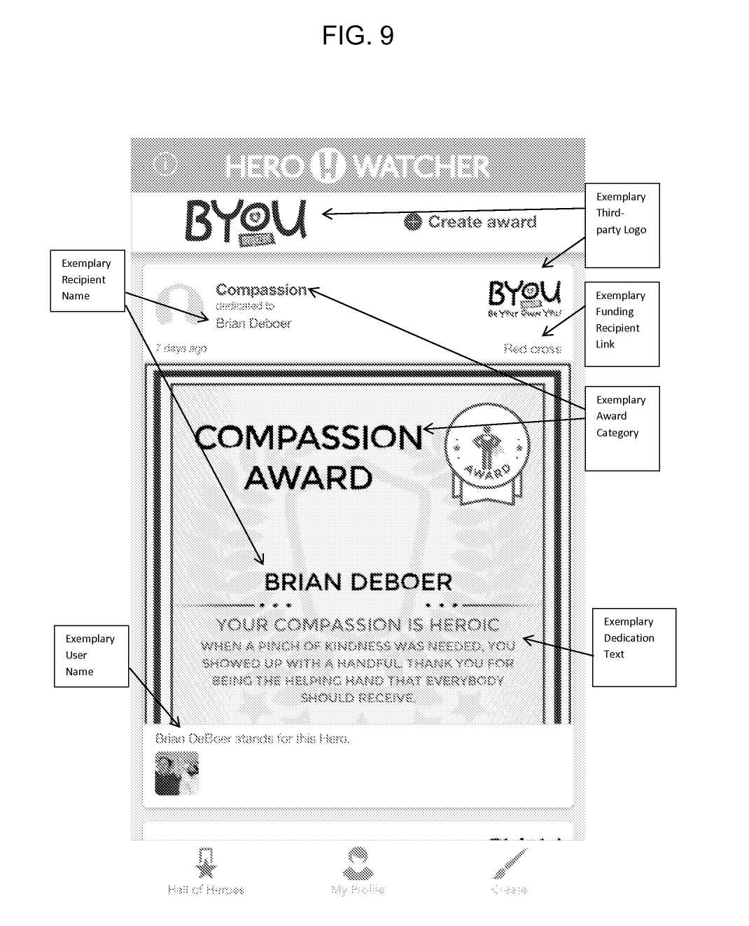

FIG. 10 shows another user interface with a second style, showing a roster board of rewarded users, according to an embodiment of the present disclosure. Names, award category, dedication text, funding recipient link and third-party logos shown are exemplary and not limiting.

FIG. 11 is a schematic drawing illustrating one embodiment of the present disclosure.

FIG. 12 is a flow chart illustrating one embodiment of the present disclosure.

FIG. 13, Panel A, provides a flow chart showing an embodiment of an award creation process of the present disclosure. FIG. 13, Panel B, provides a flow chart showing an embodiment of an award viewing process of the present disclosure.

FIG. 14 is a schematic drawing illustrating a computer system for performing a method of the present disclosure.

FIG. 15 is a block diagram illustrating a computer system for performing a method of the present disclosure.

FIG. 16 is a flow chart illustrating one embodiment of the present disclosure.

### DEFINITIONS

User experience: User experience (UX) refers to the visual and audio aspects of a user interface along with the manner in which a user interacts with the user interface.

Act: A behavior, an action or series of actions taken by an individual, usually to achieve a goal. An act may include an altruistic act, wherein the goal achieved does not provide direct monetary or tangible benefits to the individual performing the act.

Award: An award includes any message, image, text, audio recording, item or object that is given in recognition or in return for an act performed.

Sender: The sender is an individual or entity who sends an award to someone for performing an act. In some cases, the sender is a user associated with a user profile on a social networking platform.

Recipient: The recipient is an individual or entity who has been selected to receive an award by a sender. In some cases, the recipient is a user associated with a user profile on a social networking platform.

Online platform: An online platform includes any virtual space where users can view content and/or interact with other users over a communications network. Online platforms includes social networking/media platforms (e.g., Facebook®, Twitter®, Pinterest®, Instagram®, LinkedIn, Google+™, Yelp™, etc.), third-party websites (e.g., company websites, non-profit organization websites, etc.), and the provider website/social networking platform. An online platform may be accessible by any computing device that is capable of accessing the internet, such as a mobile device, a general purpose or a specialized computer, etc. An online platform may be publicly accessible, or may be private, e.g., may have restricted online access to only those individuals authorized by the award recipient.

Communally accessible: An online platform is communally accessible when content of the online platform is accessible (e.g., viewable, visible, interactable) by any members of a community. Such a community may include users of an online social networking site for incentivizing behavior, as described herein; a network of users on a third-party social networking platform (e.g., friends on Facebook®, followers on Twitter®, etc.); or any user with online access, etc. A communally accessible online platform may be a public platform or a private platform. In certain embodiments, a communally accessible online platform excludes cases where content sent by a sender to one or more designated recipients is accessible only by those recipients.

### DETAILED DESCRIPTION

Before the various embodiments are described, it is to be understood that the teachings of this disclosure are not limited to the particular embodiments described, and as such can, of course, vary. It is also to be understood that the terminology used herein is for the purpose of describing particular embodiments only, and is not intended to be limiting, since the scope of the present teachings will be limited only by the appended claims.

The section headings used herein are for organizational purposes only and are not to be construed as limiting the subject matter described in any way. While the present teachings are described in conjunction with various embodiments, it is not intended that the present teachings be limited to such embodiments. On the contrary, the present teachings encompass various alternatives, modifications, and equivalents, as will be appreciated by those of skill in the art.

Where a range of values is provided, it is understood that each intervening value, to the tenth of the unit of the lower limit unless the context clearly dictates otherwise, between the upper and lower limit of that range and any other stated or intervening value in that stated range is encompassed within the present disclosure.

The citation of any publication is for its disclosure prior to the filing date and should not be construed as an admission that the present claims are not entitled to antedate such publication by virtue of prior invention. Further, the dates of publication provided can be different from the actual publication dates which can need to be independently confirmed. To the extent the disclosure or the definition or usage of any term herein conflicts with the disclosure or the definition or usage of any term in an application or publication incorporated by reference herein, the instant application shall control.

It must be noted that as used herein and in the appended claims, the singular forms “a,” “an,” and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which can be readily separated from or combined with the features of any of the other several embodiments without departing from the scope or spirit of the present teachings. Any recited method can be carried out in the order of events recited or in any other order which is logically possible.

One with skill in the art will appreciate that the present invention is not limited in its application to the details of construction, the arrangements of components, category selections, weightings, pre-determined signal limits, or the steps set forth in the description or drawings herein. The invention is capable of other embodiments and of being practiced or being carried out in many different ways.

### Methods

As summarized above, aspects of the present disclosure include a computer-implemented method of rewarding someone who has performed an act that an award sender considers merits an award. In some embodiments, the disclosed methods and systems facilitate the creation, monitoring, sending/receiving, publication, viewing and/or interaction with such awards and address issues unique to such creation, monitoring, sending/receiving, publication, viewing and/or interaction in the context of the Internet and as integrated with various social media platforms. Implementations of the computer-implemented method and system of the present disclosure will be illustrated with reference to the accompanying drawings.

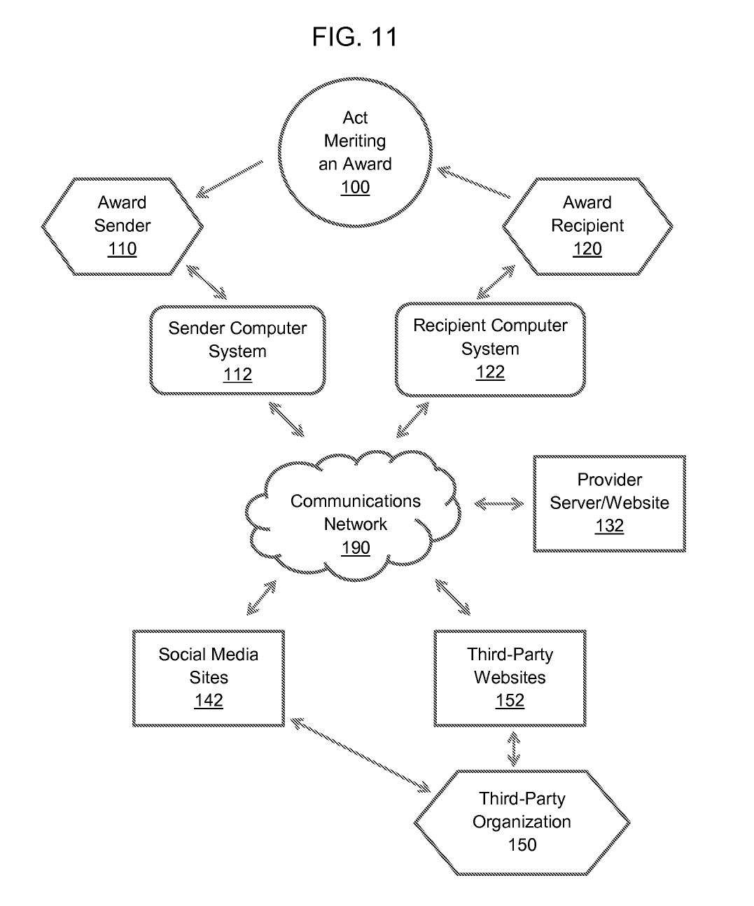

FIG. 11 is a high-level diagram illustrating an embodiment of the present disclosure. When an award sender 110 recognizes an act that merits an award 100 performed by an award recipient 120, the award sender 110 creates or selects an award via a user interface provided on a computer system 112. The award is sent to the award recipient 120 via a communications network 190, and the award may be received by the award recipient 120 via a computer system 122, at which point, the award is posted on a communally accessible (e.g. public) online platform, e.g., a social media platform 142, a third-party website 152, and/or public or private provider website 132. In certain embodiments, the award recipient 120 is asked to authorize the sender 110 to publicly display content regarding the award, and the content is displayed on a social media site 142 and/or provider website 132 and/or third-party website 152 upon receiving the authorization. In some cases, the content regarding the award displayed on the social media site 142 contains a link to the award on the provider server or website 132, and/or a link to a third-party website 152, and/or a link to report abuse to the provider. Third-party organizations 150 associated with third-party websites may include, but are not limited to, non-profit organizations and non-governmental organizations (NGOs) such as Doctors Without Borders, International Red Cross, Teach for America, Habitat for Humanity, United Nations Children's Fund (UNICEF); consumer brands, including for-profit companies; online and traditional media, etc.

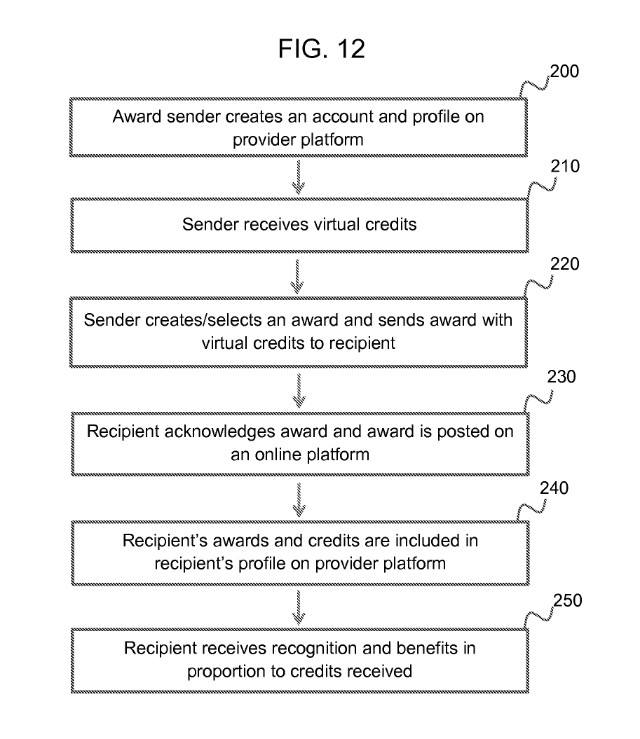

FIG. 12 is a flow chart illustrating an embodiment of the present disclosure. The award sender creates a user profile and account on the provider platform 200, if the award sender has not already done so, on a user interface such as that provided on the computer system 112. The user account is provided with virtual credits 210 that the sender can use to create/select and send an award to a recipient. The sender creates a new award or selects a preexisting award, customizes the award for the particular recipient and the act performed, and sends the award to the recipient 220. In certain embodiments, the award is sent in conjunction with transfer of virtual credits from the senders account to a user account associated with the recipient. When the recipient receives the award, the award is posted on a communally accessible (e.g., public) online platform 230. The awards received by a recipient are included in the recipient's user profile 240. As the recipient accumulates awards and credits, the recipient becomes eligible for recognition awards and benefits 250 that are provided by a third-party organization.

In certain embodiments, the virtual credits are time-restricted credits. “Time-restricted,” as used herein, refers to the credits having a value associated therewith for a limited amount of time. In some cases, the value of the virtual credits decay in a time-dependent manner, e.g., the value of the virtual credit decreases by range of 1% to 100%, e.g., 5% to 80%, 10% to 60%, 15% to 50%, 20% to 40%, 1% to 20%, 5% to 15%, 50% to 100%, 60% to 90%, or 70% to 80% after a time period in the range of 1 day to 1 year, e.g., 2 days to 6 months, 5 days to 3 months, 2 weeks to 1 month, 1 day to 2 weeks, 2 days to 1 week, 3 days to 5 days, 1 month to 1 year, 2 months to 9 months, including 3 months to 6 months. In certain embodiments, the virtual credits expire (i.e., the value of the virtual credit steps from the initial value to zero) following a predetermined time period, such as a time period in the range of 1 day to 1 year, e.g., 2 days to 6 months, 5 days to 3 months, 2 weeks to 1 month, 1 day to 2 weeks, 2 days to 1 week, 3 days to 5 days, 1 month to 1 year, 2 months to 9 months, including 3 months to 6 months. In some embodiments, the virtual credits are conditionally time-restricted credits, wherein the time dependence is reset upon the sender successfully rewarding the award recipient. Thus, in such embodiments, the time restriction is dependent on the amount of activity, such as successfully sending an award, standing for an award recipient (as described further herein), etc., of the user with the virtual credit. In some instances, each time a user with virtual credit successfully sends an award to an award recipient, the time period for the virtual credits in the account associated with the sender's user profile to decay or expire is reset to a predetermined time period, as described above.

In certain embodiments, the award sender receives virtual credits over a time interval. Thus, in some instances, a first amount of virtual credits may be added to an account associated with a user profile over a predetermined time interval, e.g., every month. In some embodiments, the amount of virtual credits added to an account associated with a user profile over a predetermined time interval may increase based on the level of participation, e.g., the number of awards sent successfully, by the user.

In some embodiments, the award recipient receives virtual credits in an account that is associated with the award recipient user profile. The credits and/or awards received by the recipient may be linked to third party awards and other incentives, as described further herein.

### Award Creation

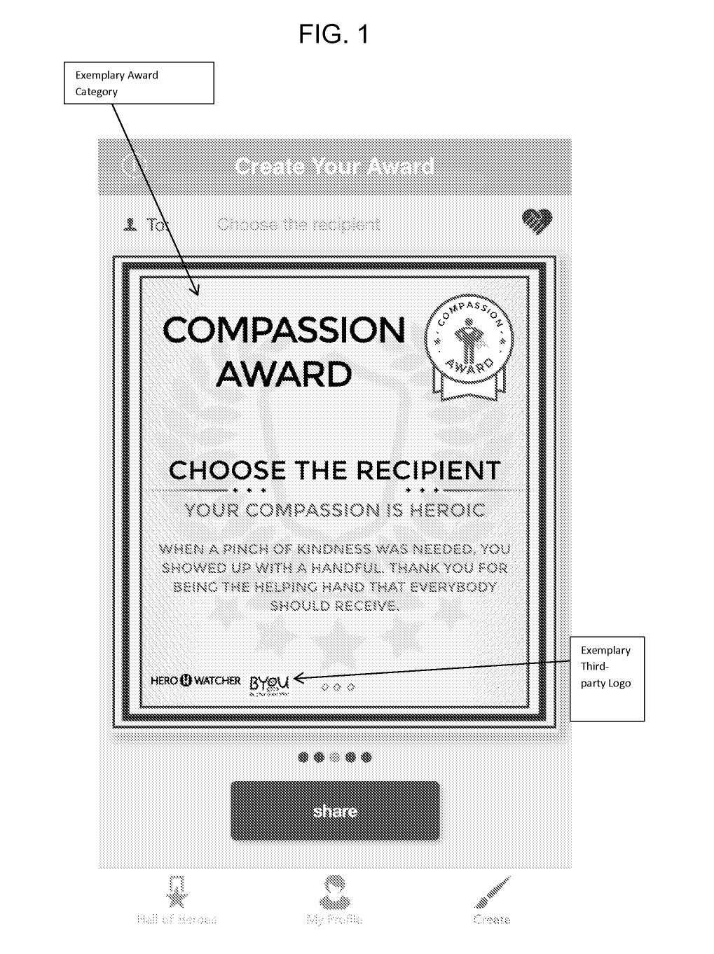

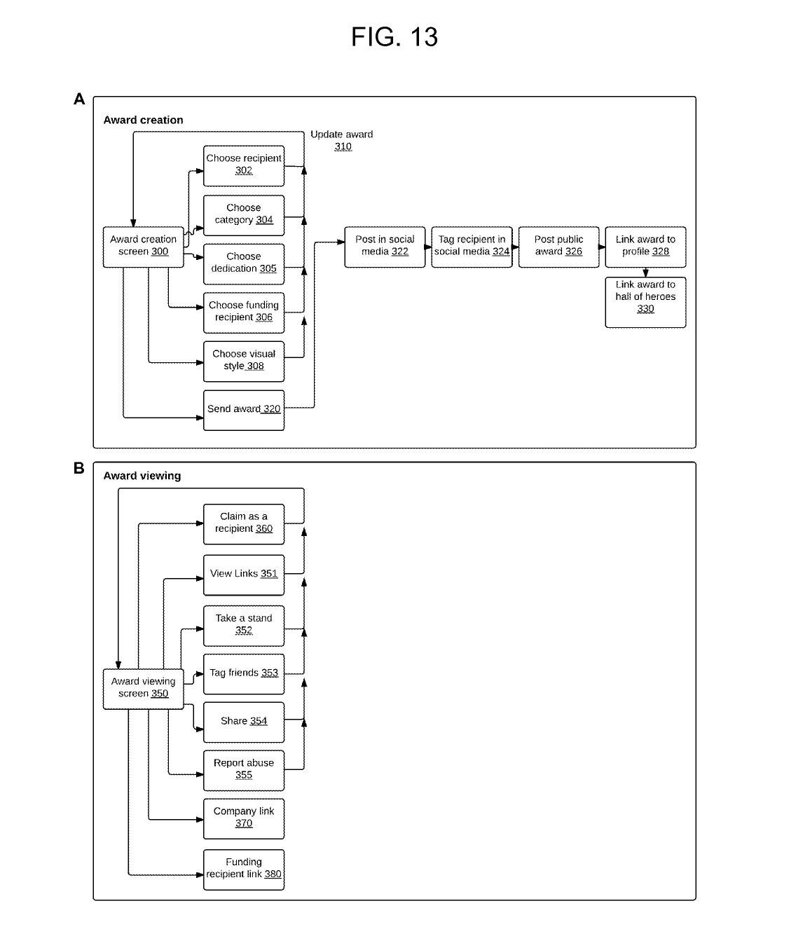

FIG. 13 panels A and B show flow charts illustrating embodiments of the present disclosure. Specifically, FIG. 13 panel A illustrates the steps for award creation (see also, FIGS. 1-6). In one implementation of the method, the award sender is presented with a default award on a user interface such as that provided on the computer system 112. The award creation user interface (FIG. 1) may include an award creation screen 300 in a combination of hyper-text markup language (HTML)/cascading style sheet (CSS), images and/or other elements, that displays a template award with an empty space (or temporary place holder) for the recipient of the award, the award category and the dedication text, as well as a default visual style. The sender is shown buttons or a touchable/clickable version of the award that allows them to select what the sender would like to do next in customizing the award, including the following options: a. choose recipient; b. choose category; c. choose dedication text; d. choose funding recipient; or e. send the award. Options may be chosen through any suitable means of interacting with a visual interface including clicking, touching, shaking the device, swiping the screen right or left with their finger, or other means.

In certain embodiments, the award creation page is co-branded/partnered with a third-party organization, such as a for-profit company (e.g., Coca-Cola) and/or funding recipient (e.g., a nonprofit, American Cancer Society), and default template for the co-branded award includes at least one of the following: a. the co-brander's logo b. the co-brander's description c. the co-brander's color scheme d. the co-brander's call to action.

When the sender selects the option to choose a recipient, the sender is presented with a list of friends (or contacts) obtained from a third party social media profile with checkmark boxes or other selection option attached with each name 302, including a call-to-action to choose a recipient of the award. Alternatively, instead of the checkbox, selections can be marked by highlight, underscoring, changes in font size, style or color, or other visual presentation that sets one option differently from others.

In certain embodiments, the sender is logged in or identified through other means, recipient field is pre-filled with one of the sender's friends obtained from a third party social media profile, and/or chosen based on past behavior on the platform, or information associated with the IP address, cookie or other digital identifier. In some instances, the sender is provided with a selectable list of individuals obtained from a user profile associated with the sender on a third party social networking platform. In some cases, the sender can start typing the name of the recipient to find the recipient among the sender's list of friends (or contacts).

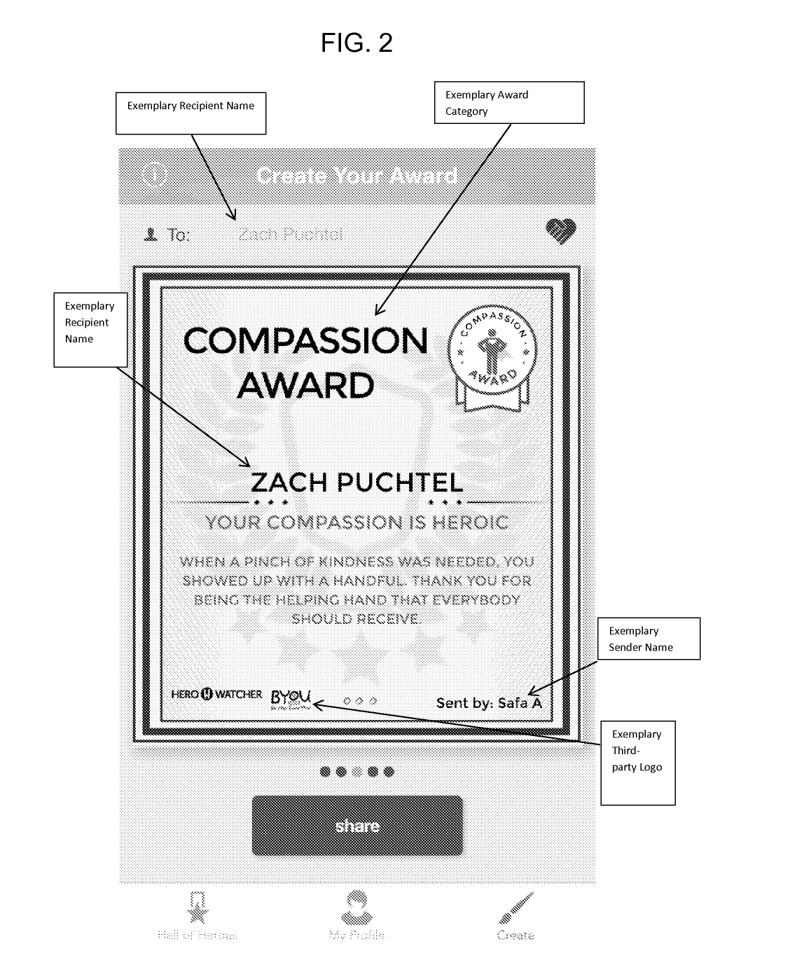

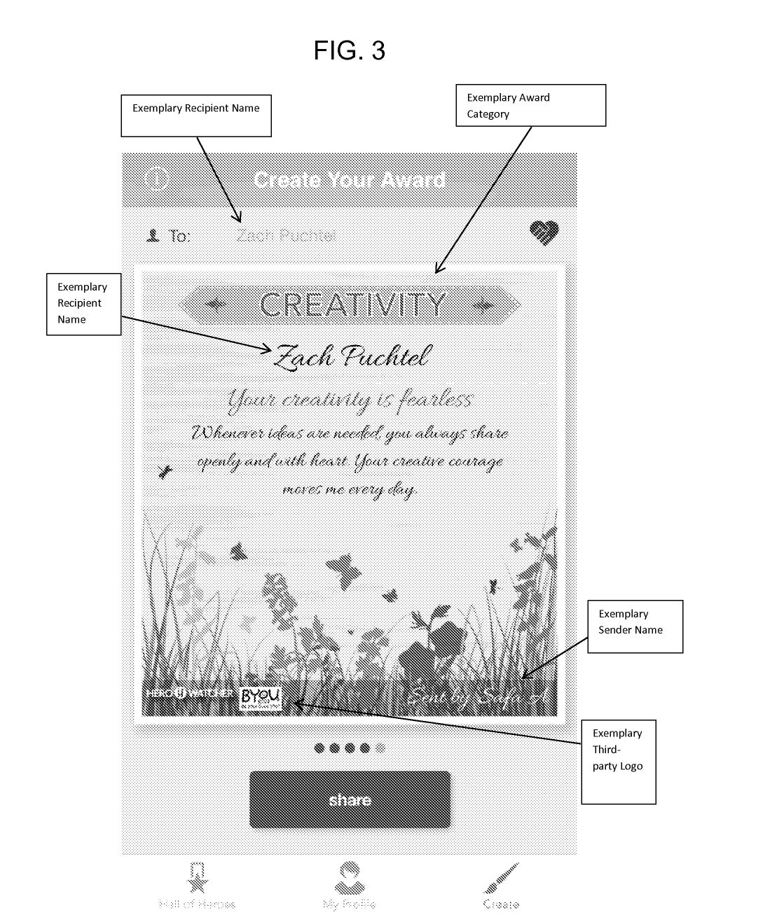

When the sender selects an award recipient, such as one of the individuals from the list of friends (or contacts), the award is visually updated 310 to include the name of the recipient (e.g., “This is an award of Joe Smith”), where the name of the recipient may appear at least once in the award, in either full or shortened form (e.g., nickname, full first name followed by initial of last name) (FIGS. 2 and 3). In some cases, the sender maybe shown a list of previous award the recipient has received.

In certain embodiments, an image related to the recipient (e.g., the recipient's picture) is incorporated into the award—an image that is either uploaded by the sender, obtained from the sender's social media profile, or through other digital means (e.g., google search).

When the sender chooses to create a new award for the recipient, the sender is shown a pre-defined list of award categories 304 (e.g., “Generosity,” “Honesty,” “Patriotism,” “Creativity”) which are accompanied by a visual selector (e.g., checkbox mark). The sender chooses one or several award categories by touching, clicking it or by other means of interaction with the user interface. In certain embodiments, the sender can create a new award category (e.g., “Brilliance,” if brilliance is not one of the default categories) up to a maximum number of characters. In certain embodiments, the list of award categories is created at least partly based on past behavior on the platform, either of their own or others (e.g., previously chosen award categories or those in which the individual took a stand), or information associated with the IP address, cookie or other digital identifier of the sender.

Categories of awards may include, but are not limited to, Ambition, Compassion or Kindness, Bravery or Courage, Creativity, Dependability, Commitment or Resilience or Determination, Focus, Generosity or Giving, Honor, Humor, Integrity, Joyfulness, Inspiration, Brilliance or Insight, Wisdom, Wonder, Power of Voice, Patriotism. In certain embodiments, award categories may further include Scientific Brilliance, Musical Creativity, Business Judgment, etc. In some instances, the categories of awards may symbolize one or more of volunteerism, leadership, bravery, generosity, patriotism, creativity, intelligence, contributions to local causes (e.g., town, city, neighborhood causes), contributions to overseas causes (e.g., participating in or contributing to international aid organizations, such as Doctors Without Borders, International Red Cross, Teach for America, United Nations Children's Fund (UNICEF), etc.), and the like.

In certain cases, the sender is shown a user interface with a list of previous award the recipient has received and may be able to choose one of the past awards the recipient has received to request a role in one of them (e.g., take a stand in one of the previous awards), or to choose to create a new award instead, or both, by clicking, touching the screen, or through other mean.

If a previous award that the recipient has received is selected by the sender, the sender is shown a user interface where the sender can choose to take a stand for the previously received award. When a user “stands for” an award recipient, the award on the recipient's profile may be tagged with the user's profile to indicate that the user supports the cause for which the recipient received the award.

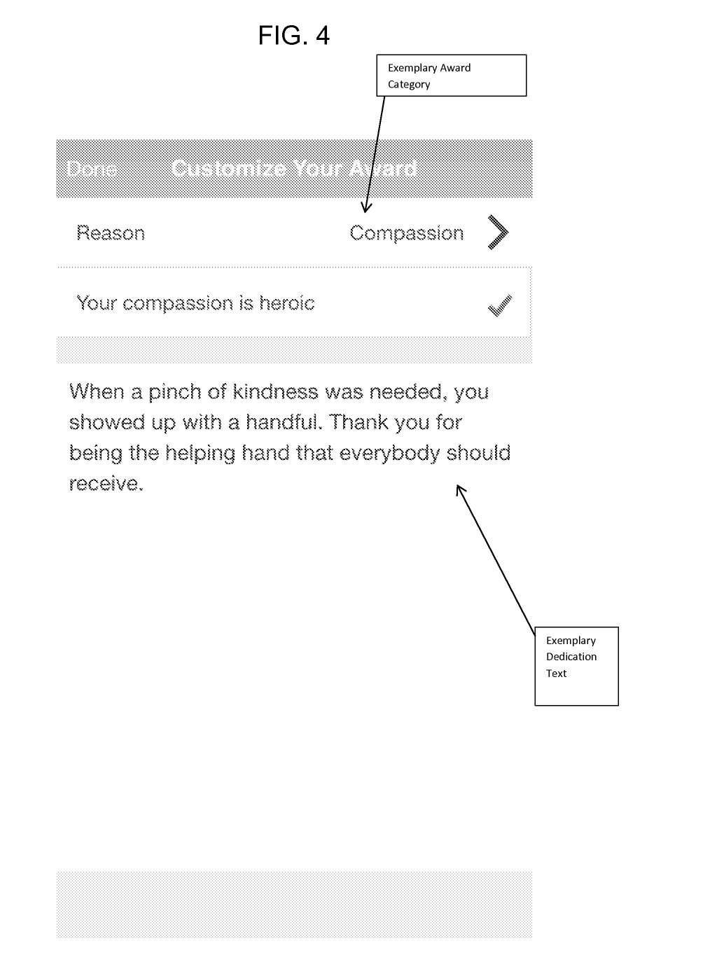

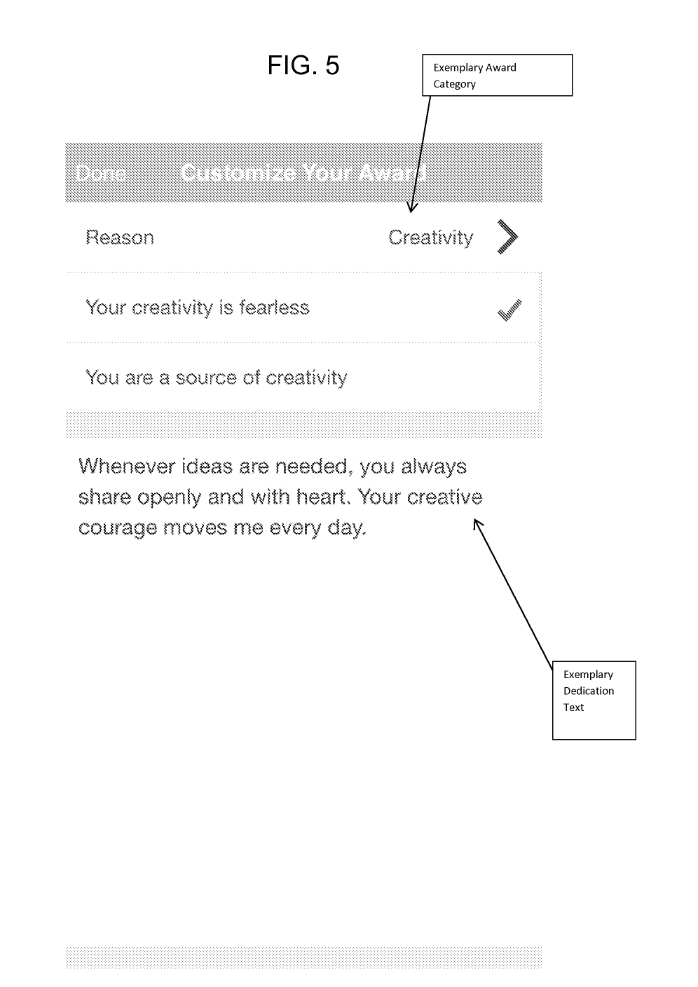

In some embodiments, at least one dedication text is associated with an award category (FIGS. 4 and 5), and the associated dedication text is displayed on the updated award.

When the sender chooses the option to choose a dedication text, the sender may be shown a user interface to choose a dedication text 305 by touching, clicking it or other means of interaction with user interface (FIGS. 4 and 5). In some embodiments, the user interface is configured to allow the sender to edit the dedication text by first clicking in the box in which that dedication text is shown, and then typing on the virtual or physical keyboard. In certain embodiments, a limit exists on the number of characters that can be incorporated into the dedication text. When the dedication text is selected or entered, the award is visually updated 310 to include the dedication text, fully or at least a portion thereof.

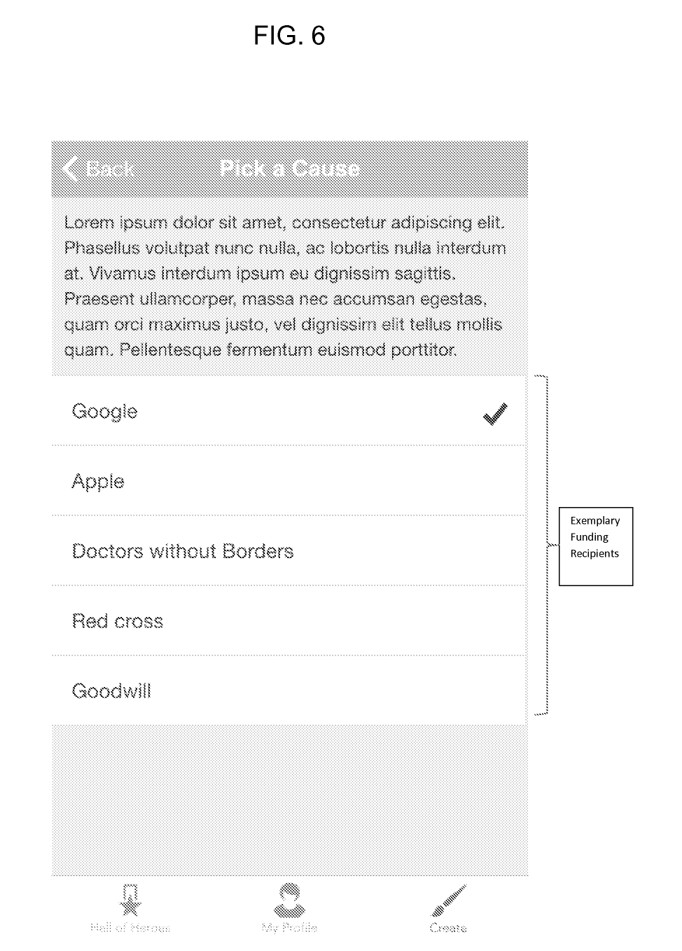

When the sender chooses the option to choose a funding recipient, the sender may be shown a pre-defined list of funding recipients 308, which could include non-profit organizations, governments, private companies or other (e.g., “Red Cross,” “Habitat for Humanity”, “Acme Inc.”) which are accompanied by a visual selector (e.g., checkbox mark) (FIG. 6). “Funds” as used herein includes a donation, monetary or otherwise, given to an organization, e.g., a non-profit organization, as well as investment in a company in return for equity in the company by a user of the instant service. The sender then chooses one or several funding recipients by touching, clicking it or other means of interaction with user interface.

Award or area surrounding it is visually updated 310 to include the name of the funding recipient, in full or at least an identifiable portion thereof.

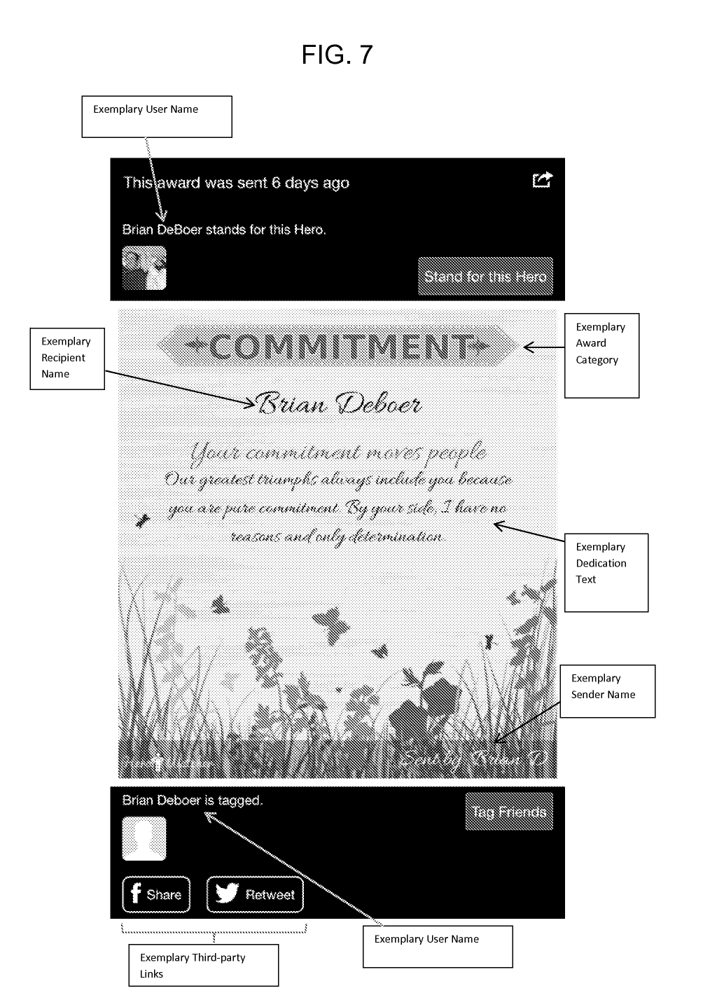

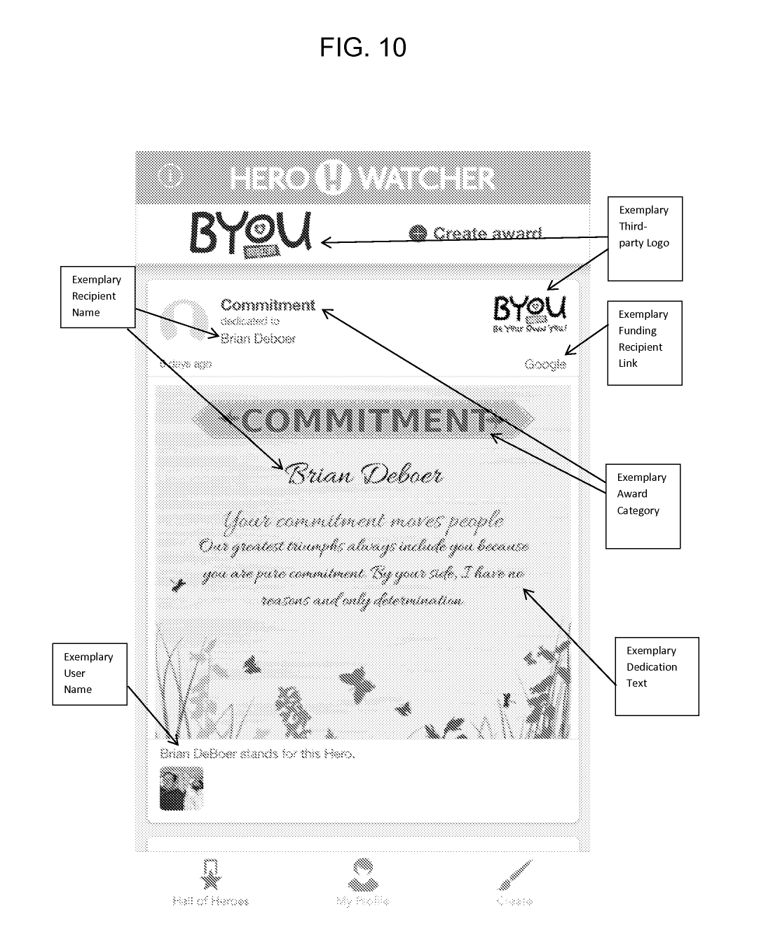

In certain embodiments, the user, e.g., sender is given an option to choose a different visual style than the default style 306 (FIGS. 3, 7 and 10). This may be done by showing a list of visual styles from which the sender can choose using any way of interacting with a visual interface. In certain embodiments, the sender is shown a list of visual styles from which they can use using any way of interacting with a visual interface (e.g., tapping on their preferred style, swiping left or right with their finger or stylus to choose a visual style that is applied to the award after the swipe).

In certain embodiments, the initial award category, dedication text and/or visual style is chosen based on past behavior on the platform, either of their own or others (e.g., previously chosen award categories or those in which the individual took a stand), or information associated with the IP address, cookie or other digital identifier. In some cases, the categories are recommended from friends' (or contacts) choices. In certain cases, the categories are recommended from people who live nearby (e.g., in proximity to the sender). In some cases, the categories are suggested from aspirational fingerprint of the sender. An “aspirational fingerprint,” as used herein, refers to one or more characteristic patterns (or a representation thereof) of a user's activities related to an award (e.g., awards given or received by the user, causes or people for which a user has taken a stand, awards viewed, the amount of time spent viewing an award, awards shared, awards for which a user tagged other individuals, etc.) that is indicative of the categories of causes that are important to the user and/or the level of engagement in any given cause demonstrated by the user. In some instances, the aspirational fingerprint of the user can be used to increase the likelihood of providing information aligned with the user's interest. Thus, in some embodiments, the present method and social networking system for rewarding an act that merits an award include generating an aspirational fingerprint of the award sender based on the sender's user profile and recommending categories of awards based on the aspirational fingerprint. In certain embodiments, the aspirational fingerprint may be determined through supervised or unsupervised machine learning using the information available in the user's profile, e.g., the categories of awards successfully sent by the user, or for which the user stands, or for which the user is designated as an ambassador, as described further herein, etc. Further aspects of the aspirational fingerprint, and creation and use thereof are described below.

When the sender has created the award, the sender may send the award to the recipient 320. The award is created in visual (e.g., an image in combination with HTML/CSS code, a PNG image file, a JPG image file) or text (e.g., plain or stylized text) form, or a combination of the two forms, based on the previous selections including at least a recipient, award category, and optionally a dedication text and funding recipient, and may be visually styled according to the selected visual style. In some embodiments, one or more audio and/or video recordings may be included as part of the award.

In certain embodiments, when a co-branded or partnered award is created, it contains a single or multiple references to the partner selected from the following list: logo, color scheme, description or call to action. In some embodiments, the co-branded or partnered award contains a single or multiple references to the partner selected from the following list: logo, color scheme, description or call to action, button or link to the company's HTML/CSS page, button or link to a non-profit's HTML/CSS page.

In certain embodiments, before the award is created, one or a combination of methods are used to determine if the award meets publication standards, including a. comparing sequences of characters typed in the dedication text with a table of words that have been banned (e.g., swear words, “HTTP” to eliminate web site links) b. comparing sequences of characters with a standard dictionary to ensure that at least 10%, e.g., at least 30%, at least 50%, at least 70%, or at least 90% of the words are present in the language (i.e., avoid a nonsensical award) c. using other standard methods for linguistic analysis by software or hardware. If the award fails the publication standard test, the sender may be presented a visual warning that their award needs to be re-edited before it can be published, or in some cases the sender may be told the award is about to be published but is not posted online. In some embodiments, the administrators of the website are notified of the failed award creation. In some embodiments failure of an award to meet the publication standard test results in a reduced likelihood of the award's publication.

In certain embodiments, a sent award is posted in one or several social media sites 322 (e.g., Facebook®), and may include in addition at least one of the following as images, other media (e.g., video, audio), text, HTML/CSS representations or native mobile app format in the caption: a. explanation of award; b. a link to request the award as a recipient (i.e., a link that allows a user on the social media site to acknowledge or confirm that the they are the intended recipient of the award, upon the user selecting the link); c. a link to the award on a website or social media 142; d. a link to take a stand or request a role; e. link to tag others or publicize the award through various means (e.g., retweet on twitter, share on Facebook®); f. a link to report abuse; g. a link to one or several websites 152 (e.g., the funding recipient, a consumer brand, a company); h. a link to donate or contribute resources to a particular funding recipient 150. Social media 142 options include Facebook®, Twitter®, Instagram®, LinkedIn®, Pinterest® or others. In addition, the award may contain at least one field of information provided above (e.g., recipient name) that is specific to a particular award (i.e., could be selected by the sender) and may be incorporated in HTML tags that are readable and indexed by search engine indexing software (e.g., META TITLE and KEYWORD tags) to enable the award to be found through search engines when a sender searches for that field of information (e.g., through Google™).

In certain embodiments, the award in a social media site is tagged to the recipient's social media profile to alert the recipient of that the award was sent to them and/or the funding recipient social media profile (e.g., image or comment tag in Facebook® or @tag on Twitter®) to achieve a similar notification. In some embodiments, hashtags (#) followed by a relevant text is incorporated in the posting of the award on social media to attract the relevant type of online traffic and attention. In some embodiments, the sender's and/or recipient's friends list (or contact list) on a social media site is analyzed to identify a subset of their friends (e.g., mutual friends with the recipient, the sender's friends with whom they interact most often), who are also tagged in the award to draw their attention 324.

In some embodiments, the method includes creating two digital visual representations 328 that represent, respectively, the sender's and recipient's profiles on the platform that may include for each profile at least one of the following: the awards that a user has sent (as sender), received (as recipient) or stood for (see Take a stand below); this visual representation may be a repository of all award related activities for a particular user of the system. In some embodiments, the listing is in text, visual, video, animated or audio form. In some embodiments, the two visual representations also contain next to each award a link to share the award through social media. In some embodiments, at least one of the following types of information is stored in a database or file system, local or remote, that links them to each particular user of the system: a. award category; b. award dedication text; c. award visual style; d. award recipient; e. award sender; f. physical location of sender or recipient (as determined by a localization performed on basis of IP address or geo-location through GPS of a mobile device); g. all social media data obtained through the login process; and h. behavioral data (e.g., which screens of the app the user spends their time, where they touch the screen).

In some embodiments, the award is posted on a third-party, public website 326, and includes at least one of the following: a. an explanation of the award; b. a link to request the award as a recipient (i.e., a link that allows a user to acknowledge or confirm that the they are the intended recipient of the award, upon the user selecting the link; c. a link to the award on a website or social media 142; d. a link to take stand or request a role; e. a link to tag others or publicize the award through various means (e.g., retweet on Twitter®, share on Facebook®); f. a link to report abuse; g. linked to one or several sites 152 (e.g., the funding recipient, a consumer brand); h. a link to donate or contribute resources to a particular funding recipient 150. In some cases, the information is also placed in META tags to enable search engine optimization, and easy discovery of the award through search engines.

In some embodiments, the award is accessible on a private platform and may include at least one of the following: a. an explanation of the award; b. a link to request the award as a recipient (i.e., a link that allows a user on the private platform to acknowledge or confirm that the they are the intended recipient of the award, upon the user selecting the link); c. a link to the award on a website or social media 142; d. a link to take stand or request a role; e. a link to tag others or publicize the award through various means (e.g., retweet on twitter, share on Facebook®); f. a link to report abuse; g. a linked to one or several sites 152 (e.g., the funding recipient, a consumer brand); h. a link to donate or contribute resources to a particular funding recipient 150.

### Award Viewing

Also provided herein are computer-implemented methods for rewarding an act, as described above, wherein the method further comprises providing a user interface to a user for viewing an award. An implementation of the method is described with reference to FIG. 13 panel B.

In certain embodiments, the method includes providing a user interface 350 that allows an individual or software (e.g., spider robot), here referred to as “user,” to visit the URL of a HTML page and display the award created by the methods for creating an award, as described above, and posted on a communally accessible (e.g., public) online platform. In some embodiments, an individual or software (e.g., spider robot) visits a representation of the award in a mobile device (e.g., in an app) through a non-HTML representation that is native to that platform or enabled by a third-party piece of software or hardware. The award may be shown to the user in some visual representation (e.g., HTML/CSS, native mobile app screen) and may include in addition at least one of the following as images, other media (e.g., video, audio), text, HTML/CSS representations or native mobile app format: a. an explanation of award; b. a button to “claim award as recipient” (i.e., a button that allows a user on the online platform to acknowledge or confirm that the they are the intended recipient of the award, upon the user selecting the button; c. a button to “view URL links to the award”; d. a button to “take a stand”; e. a button to “tag others”; f. a button to “share” or publicize the award through various means (e.g., retweet on twitter, share on Facebook®); g. a button to “report abuse”; h. a button to a website associated with a company; and/or i. a button to a website associated with a funding recipient (e.g., a nonprofit organization). In some embodiments, the buttons are replaced with any interactable user interface element that allows the user to visit a visual page (e.g., HTML/CSS, mobile app screen) that achieves the same or similar objectives. In some embodiments, some or all of the buttons or User Experience (UX) elements may not be working or deactivated, so as to provide awareness (e.g., the company link with call to action) but not drive online traffic to the external property.

In certain embodiments, the method includes determining if the user is already logged in through the social media site of the sender of the award, when the user selects the “claim award as recipient” option 360. In certain embodiments, the determining includes downloading the user's list of friends (or contacts) from the social media site including any other data that the social media site provides through their Application Program Interface (API) or other means and checking the user's list of friends (or contacts) to see if the sender's name is present. Following identification of the sender's name in the user's list of friends, the award is linked to the recipient using a database index field, as recipient of the award. In some cases, the determining includes checking for a match of other information of the sender on the list if available (e.g., email, date of birth, phone number) to increase the likelihood of a correct match (i.e., to eliminate possibility that there's a an individual in the recipient's list of friends that only happens to match the name of the sender but is not the original sender, and thus has a different birthdate). Upon determining the user to be the recipient, the method may include adding an image, video, audio or other media associated with the recipient to the Award Viewing page.

In certain embodiments, in case where the social media site provided a personally identifiable ID of the recipient when the award was sent, the recipient may be automatically determined by comparing their personally identifiable ID versus that of the current user; in the case that a match is found, then the user is identified as the award recipient.

When the “view URL links to the award” is selected by the user 351, list of links including at least one of the following is shown on the user interface: a. a URL link to the award on a public website; and b. a URL link to the award on a social media website. In some cases, the number of clicks is tracked and forwarded to the URL that was requested.

When the “take a stand” option is selected by the user 352, the user may be prompted to login, if not already done so. Then, the profile image of the user, or other image, video or audio representation, of the user is visually added to the award viewing page. In some instances, the number of times a user can take a stand for an award or recipient is limited within a given time interval. In some instances, upon the user selecting the “take a stand” option, a maximum number variable is set to be equal to X (where X is a number smaller than 1 billion) and a time variable is set to a value in the range of 1 to 86400 seconds. Then, data is obtained for how many stands the user has took for the last set period of time going backwards from the present, and saved as a stand per time period variable. In certain cases, data of how many stands the sender has taken for the last time variable that ended at the last local midnight (or other fixed time point of each day) may be obtained, and save as stand per time period variable. If the stand per time period variable is equal to the maximum number variable, the user is notified that they cannot take a stand. The stand per time period variable is increased by one otherwise. Any other mathematical function that limits the number of stands performed per period of time may be used. In some embodiments, the share process 354 is automatically called (i.e., whenever someone takes a stand, they also trigger process to share the award on social media).

When the “tag others” option is selected by the user, the user may be prompted to login, if not already done so. Then, the user's list of friends from the social media site including any other data that the social media site provides through their API or other means is downloaded. In some instances, the list of friends is shown and the user is allowed to select which to tag (e.g., with a tag button next to their name). The list may be ordered based on order provided by social media or other metric (e.g., frequency of communications). In some cases, the user may be allowed to type the name of a friend to find them in the list. After selecting a friend, the method may include determining if it is possible to add tags to the last social media posting of the award (i.e., if the social media API allows it). If possible, additional tags that link the award to the friends who have been selected for tagging in immediately previous steps are added. If it is not possible to add tags, new award postings on social media may be create with the new tags. In some cases, a profile image of the tagged friends, or a subset of them, or other image, video or audio representations, is visually added to the Award viewing page.

When the “share” option is selected by the user, the user may be prompted to login, if not already done so. Then, standard API calls are used to share the award on the relevant social media site (e.g., Facebook®, Twitter®). In some instances, the number of shares that have taken place is tracked and displayed (e.g., as a number next to the relevant social media icon). In some cases, the method includes providing a link to create a physical version of the award that can be shared with others (e.g., a printed award to be shared with the recipient).

When the company link is selected by the user, the number of times the link is selected may be counted, and the user is sent to the URL of the company (e.g., Coca Cola, Johnson & Johnson).

When the funding recipient link is selected by the user, the number of times the link is selected may be counted, and the user is sent to the URL of the funding recipient (e.g., a non-profit such as UNICEF, a social enterprise like TOMS shoes, a crowd-funding project).

When the “report abuse” option is selected, the user may be prompted to login, if they have not already done so. Then an abuse counter variable associated with the award may be increased by one. In some cases, the ID of the user who reported the abuse is recorded in a table, database, or other digital repository of information. Then, a notification (e.g., email, SMS) may be sent to individuals who administer the platform to notify them of potential abuse. In some embodiments, an abuse count variable is set to be equal to X (where X is a number smaller than 1 billion); if the abuse counter variable is greater than abuse count variable, then the award is disabled so that no individuals can view it, and/or a notification is sent to the individuals who administer the platform. In some instances, the method includes a process that determines if there has been a maximum number of report abuse events reported per period of time (rather than over all time); if the maximum has been crossed for a specific period of time, then either the administrators are notified and/or the award is disabled.

### Aspirational Fingerprint

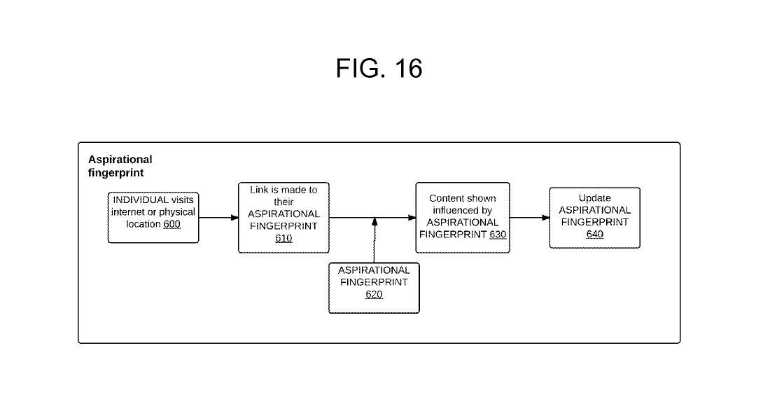

Also provided herein is a computer-implemented method including generating an aspirational fingerprint based on a category and/or content of an award created and/or selected by an award sender, as described herein, and a computer-implemented method of utilizing a personalized behavior profile of an individual using the aspirational fingerprint (FIG. 16).

An aspirational fingerprint may include any data associated with at least one user and is generated by analyzing the data to create, e.g., a numerical, visual or textual representation that reflects what are the mindsets, behavioral, attitudes or capabilities they find the most attractive, inspiring or emotionally engaging to them—for example, a list can be generated of what award categories they have supported in the past (whether by creating, tagging, taking a stand for and/or sharing an award in that category), which can then be analyzed to see which categories represent the most frequently supported categories (e.g., “Bravery” represents 30% of awards supported followed by “Courage” representing 20% and “Patriotism” representing 15%). In some embodiments, the aspirational fingerprint is generated by analyzing the categories of awards supported by the user, wherein the categories include: Ambition, Compassion or Kindness, Bravery or Courage, Creativity, Dependability, Commitment or Resilience or Determination, Focus, Generosity or Giving, Honor, Humor, Integrity, Joyfulness, Inspiration, Brilliance or Insight, Wisdom, Wonder, Power of Voice, Patriotism. Any standard integer or matrix mathematical or software function or combination thereof that can be used on the user's data —whether associated with award interactions 328, behavior (e.g., which awards they spend the most time viewing), social media sites from which they logged in through (as described herein) and other sources (e.g., data on their age economic status or profession obtained from third party sources and linked to them to personally identifiable ID, IP address or cookie)—to generate an aspirational fingerprint.

Any supervised learning algorithm that is trained to generate an aspirational fingerprint based on the data sets mentioned in this step (e.g., neural network). One or more behavioral targeting methods or suitable components thereof may be utilized in connection with the disclosed methods or one or more steps thereof. For example, U.S. Patent Application Publication Nos. 20150039424, 20150006286, and 20140200999, the disclosure of each of which is incorporated by reference herein in its entirety and for all purposes, describe various behavioral targeting methods and machine learning models, which may be implemented in connection with the methods disclosed herein, e.g., in the generation of a user's aspirational fingerprint.

Any of the data sets or approaches (e.g, unsupervised, supervised, other) may be applied to the data associated with individuals who are their friends (or contacts) on other social media sites, or individuals who have interacted with them through the award process including at least created an award for the user, received an award from the user, or took a stand or tagged a friend or shared an award created by the user or sent to the user.

In some embodiments, generating the aspirational fingerprint includes tracking the behavior of an individual online and/or in a brick and mortar store off line. Thus, an individual may be tracked when they visit either an internet property (e.g., a website, the email platform they use to send or receive emails), mobile app (e.g., iOS® or Android® app) or physical location (e.g., movie theater). The behavior of the individual may be assigned to a user in the provider system based on a number of criteria. In some cases, the individual is identified to be—with a likelihood of 1% or higher, e.g., 10% or higher, 20% or higher, 50% or higher, 75% or higher, or 90% or higher—the same person as or closely related to the user through at least one of the following methods: a. they shared the same IP address over the last 3,600 or fewer days, e.g., 1,800 or fewer days, 900 or fewer days, 300 or fewer days, 100 or fewer days, or over a range of 30 to 3,600 days, 100 to 1,800 days, or 200 to 1,500 days; b. they have the same cookie on their computer software that is used to identify them; c. they have same name or other personally identifiable information (e.g., phone number, email address); d. they have used the same mobile or desktop device as identified through a unique or infrequently repeated identifier (e.g., MAC address, IPhone UDID); and e. they have used an IP address that is estimated to be geographically close to the other's IP address.

Embodiments of the present disclosure further include computer-implemented method of utilizing a personalized behavior profile of an individual using the aspirational fingerprint. aspirational fingerprint of the user, or the data sets mentioned previously, are used to determine at least one of the following: a. the messaging in advertising shown to the individual (e.g., the user who tends to support “Bravery” in awards is presented with an ad whose messaging emphasizes the Bravery of the characters or the brand); b. selection of which advertising is shown to the individual (e.g., a user who supports “Innovation” in awards is more likely to purchase an innovative technology product than someone who does not support “Innovation” in awards); c. the landing page or screen that is shown to the individual after clicking on digital advertising (e.g., someone who supports “Risk taking” in awards and clicks on advertising for a movie is taken to a page that emphasizes the risk taking of the heroes of the movie); and d. the non-advertising content that is shown to the individual (e.g., someone who supports “Patriotism” in awards, when visiting a news site, is shown stories of patriotism). In some instances, data associated with the individual's behavior on internet properties or physical locations (e.g., which advertising they click on, how long they stay on a page) is analyzed to update their aspirational fingerprint (e.g., if they support “Bravery” on awards but do not tend to click on advertising related to “Bravery” their aspirational fingerprint is updated to reflect that they do not click on such messaging).

In some embodiments, the aspirational fingerprint data is used to determine product development decisions (e.g., it is identified that individuals between 20-30 years of age of a particular ethnic background care about X Y Z aspirations, and this is used to create a television program that targets their aspirational fingerprint). In some instances, the aspirational fingerprint data related to consumer insights are used to create or change marketing campaigns such that they are specifically tailored to the aspirational fingerprint of individuals (e.g., a TV, radio or billboard campaign has its messaging and visuals updated based on the aspirations of individuals who are known to be their consumers). In some cases, a user's aspirational fingerprint may be used to determine which ads are presented to the user on the provider website or a third-party website/social media platform. For instance, a user whose aspirational fingerprint indicates that the user shows preference for “innovation” related awards may be shown ads related to innovative products. In some embodiments, a user's aspirational fingerprint may be used to determine which one of several different versions of ads is presented to the user on the provider website or a third-party website/social media platform. For instance, a user whose aspirational fingerprint indicates that the user shows a preference for awards related to “bravery” may be shown a version of an ad for a movie that emphasizes the bravery of the characters in the movie.

### Additional Embodiments

In certain embodiments, there is provided computer implemented methods and social networking systems for rewarding an act that merits an award, including i) providing an award sender with a user interface on a computer system which allows the award sender to select an award recipient, ii) providing the award sender with an option to create an award and/or select from a preexisting award template using the user interface, iii) sending an award sender-created award and/or award sender-selected award to the award recipient based on the award sender's selection of the award recipient for having performed an act that merits an award, and iv) posting content regarding the award received by the recipient on a communally accessible online platform, wherein the user interface provides for the identification and/or selection of a funding (e.g., donation) recipient, and wherein the method comprises sending a donation to the funding recipient upon the sender selecting the award recipient for having performed the act that merits the award. In some instances, the funding (e.g., donation) recipient may be a third-party organization 150. In certain embodiments, an award is sponsored by a third-party organization 150, and the award sender is provided with a preexisting award template. In some instances, the award created by the sender may include an identifier (e.g., name or logo) for the third-party organization and a link to the third-party organization website.

In certain embodiments, the systems and methods of the present disclosure includes i) providing an award sender with a user interface on a computer system which allows the award sender to select an award recipient, ii) providing the award sender with an option to create an award and/or select from a preexisting award template using the user interface, iii) sending an award sender-created award and/or award sender-selected award to the award recipient based on the award sender's selection of the award recipient for having performed an act that merits an award, iv) posting content regarding the award received by the recipient on a communally accessible online platform, wherein the user interface provides for the identification and/or selection of a funding (e.g., donation) recipient, and wherein the method comprises sending a donation to the funding (e.g., donation) recipient upon the sender selecting the award recipient for having performed the act that merits the award, v) receiving an authorization from the award recipient to publicly display content regarding the award, and vi) publicly posting content regarding the award received by the recipient on a social networking platform 142, provider website 132, or third party website 152. The content may include one or more of an identification of the award, a description of the award, a link to request the award as a recipient (i.e., a link that allows a user to acknowledge or confirm that the they are the intended recipient of the award, upon the user selecting the link); a link to the award on the provider website 132, a link to take a stand for or request a role in the act for which the award was received, a link to tag others or publicize the award through third party social networking platforms 142, a link to report abuse to the provider, a link to one or more third party websites 152, and a link to donate or contribute resources to a funding (e.g., donation) recipient 150. In some embodiments, the identification of the award is tagged to the recipient's profile on a social network 142 and/or the profile of the funding (e.g., donation) recipient on a social network 142.

In certain embodiments, the systems and methods for rewarding an act includes maintaining a first user profile of an award sender, wherein the first user profile is linked to a second user profile of the award sender on a third-party social networking platform 142 and wherein the first user profile comprises a record of awards sent by the sender. In some embodiments, a user profile of the award recipient is provided, wherein the user profile comprises a record of awards received by the recipient. In some instances, the systems and methods for rewarding an act includes displaying a visual representation of the record of the awards received by the award recipient. In certain embodiments, the visual representation may be in the form of a “tree” which will branch and grow as more awards are received for the act. Thus the size and/or complexity and/or arborization of the tree may provide a visual representation of the record of awards received by the award recipient. In some embodiments, the trees will be publicly visible. In some embodiments, the recipient may receive an award from a third party organization after the recipient accumulates a number of awards above a predetermined threshold and be recognized for the act performed. The third party award may take any suitable form. In certain embodiments, the third party award is provided by local media, local companies and/or local governments. In some embodiments, the third party award is a local service award, such as the keys to the city granted by the local mayor. In some embodiments, the third party award is recognition by a local newspaper. In certain embodiments, the third party award is access to experiences that cannot be purchased monetarily, such as access to exclusive or restricted events and venues, private meetings with celebrities, heads of organizations and political leaders.

In certain embodiments, the systems and methods for rewarding an act includes generating a list of a plurality of award recipients ranked according to the number and/or category of awards received by each award recipient. Thus, in some cases, a roster board showing the ranking of award recipients based on the number of awards or virtual credits received is provided on the provider website or is accessible on the provider server through an app on a smart phone. In certain embodiments, the roster board shows the top percentiles of individuals receiving awards. In certain embodiments, the roster board is classified by public or private individuals. In some embodiments, the roster board ranks individuals within a neighborhood, city, industry, age group, etc. In certain embodiments, the roster boards will display the result of points awarded by individual users and not by companies or corporate users or sponsors. In certain embodiments, the roster board is augmented with in depth stories that are published, advertised and disseminated to a wider audience through, e.g., links on social network profile pages, third party websites, etc.

In some embodiments, a roster board as described above, may be represented visually (known, for example, as the HALL OF HEROES 330) and may show a sequence of awards that have been generated and sorted in one of many potential orders, including at least one of the following, or logical AND or OR combinations of the following: a. the temporal order of the award (e.g., a sequence from the newest award to older awards); b. the temporal order of users taking a stand for an award (e.g., a sequence from the award with newest event where someone confirmed to “Take a Stand” to awards with older events for which a user took a stand); c. the temporal order of users tagging friends to an award (e.g. a sequence from the award with the newest tagging of friends to awards with older tagging events); d. the temporal order of sharing of awards (e.g., a sequence from the award with newest share to awards with an older sharing event); e. the physical distance between the location of the award with the location of the user (e.g., a sequence from the award that is closest geographically to the user currently viewing the page to awards that are further away); f. the number of views for an award (e.g., a sequence from the award that has garnered the highest number of views to those with fewer views); g. the relevance of an award based on the social network interaction between the recipient and the user (e.g., a sequence from the award that involves a friend on a social media site whether as recipient, sender or someone who took a stand to awards given to recipients with no social media interaction with the user (e.g., those awards with which friends have interacted are listed first on ordering)). The user viewing the page could examine the sequence of awards using any of a number of common UX methods (e.g., swiping down or up with their finger, clicking down on an arrow pointing downwards). In certain embodiments, each of the awards in the Hall of Heroes has a link or button that allows the users to Share, Claim as Recipient, Tag friends and/or Take a stand directly from that location.

In some embodiments, a user who stands for an award recipient may be provided on the user profile page with content (e.g., an image, video, animation, visual character, etc.) that indicates that the user stands for the award recipient. In some embodiments, standing for an award recipient may be linked to benefits to the user. Benefits linked to the act of standing may include virtual credits, public recognition, financial rewards, etc. In certain embodiments, the present system and method may include providing an award recipient with an option to send a message on the provider platform or a notification, e.g., via short message service (SMS), email, push notification on an app, or other digital notification means, specifically to users who took a stand for the award recipient.

In some embodiments, the subject methods and social networking systems for rewarding an act that merits an award includes providing incentives to encourage participation by a user. In certain embodiments, the subject methods and systems include providing users with information about social gathering in their community that are related to causes that are of interest to the user, as determined, e.g., by the users aspirational fingerprint, or as chosen by the user. In certain embodiments, the subject methods and systems include providing virtual items that may be purchased with virtual credits, and that are displayed on the user's profile page. Virtual items may include, but are not limited to, philanthropic medals displayed on the user's profile page, or a virtual water well displayed on the user's profile page, where each well may fund one child to have reliable access to clean water. In certain embodiments, an award sender may receive a visual representation of the award, e.g., a tree award, for successfully sending an award. As in the virtual credit, the tree may be a time-restricted tree that decays with time, or conditionally time-restricted tree. In certain embodiments, the subject methods and systems include providing virtual medals to users whose profile receives a number of visits within a period of time that is above a predetermined threshold.

In certain embodiments the present systems and methods for rewarding an act that merits a reward includes designating one or more users as being a representative for an award recipient in a manner distinct from other award senders or users who took a stand for the award recipient. The designated representative may be selected in any convenient manner. In certain embodiments, the present system and method includes providing an award recipient with a user interface (e.g., on a second computer system), which allows the award recipient to designate one or more users as a representative for the award recipient. In certain embodiments, the present system and method includes providing an award sender or a user who took a stand for the award to send a request to the award recipient to be a designated representative. In some cases, the user's request to be a designated representative or an award recipient's request to designate a user as a representative is automatically accepted by the other party. In some cases, designating a user as a representative for an award recipient requires approval by the party receiving the request. In some instances, a request by a first user to become a representative for an award recipient may be approved by a second user who is already a representative for the award recipient.

In certain embodiments, the award recipient is given virtual credits or digital coins that may be used to designate a representative for the award recipient, where a predetermined amount of virtual credits or digital coins is transferred to the account of the user who is designated as the representative. Thus in such embodiments, a user who has been designated as representative for an award recipient receives virtual credits and/or digital coins associated with the designation. In some embodiments, a user who has been designated as a representative for an award recipient receives a link, an image, video, animation, digital character, etc., on the user profile indicating the designation. The designation as a representative of an award recipient may be further associated with tangible benefits, such as a physical award (e.g., a medal or a ring), financial payment (e.g., from a third party), or donations to their name, etc. In some embodiments, a user who has been designated as a representative for an award recipient receives messages and notifications from the award recipient specifically directed to the representatives. Thus, in some embodiments, the present system and method includes providing an award recipient with an option to send a message on the provider platform or a notification, e.g., via short message service (SMS), email, push notification on an app, or other digital notification means, specifically to designated representatives of the award recipient.

In some embodiment, a user who is designated as a representative for an award recipient is given a title (e.g., an “Ambassador”, a “Champion”, etc.) associated with the award recipient. In certain embodiments, a user may be limited in the number of award recipients they can be designated to represent, and in some cases the limit is determined by the title given as the representative of the award recipient. In some cases, a user may be designated as a representative (e.g., an “Ambassador”) for 3 to 10, e.g., 4 to 9, or 5 to 8 award recipients. In some cases, a user may be designated as a representative (e.g., a “Champion”) for one or two award recipients. In certain embodiments, the number of users designated as an ambassador and/or a champion for the recipient is limited, such that the number of ambassadors may be in the range of 3 to 10, e.g., 4 to 9, or 5 to 8, and the number of champions may be one.

In some embodiments, the present computer implemented methods and systems are tolerant to fraud and abuse of the methods and systems by an award sender and/or an award recipient. Implementation of fraud-tolerant methods and systems may involve one or more of the following. In certain embodiments, the identity of the award sender is not provided to the award recipient. Thus, in some cases, the award received by an award recipient is an anonymous award. In some embodiments, the subject methods and systems for rewarding an act that merits an award includes verifying that the sender's selecting the award recipient is not performed as a result of undue influence or fraud, and sending the award to the award recipient upon the verification. In certain embodiments, the award is canceled after it is sent to the award recipient if the verification fails.

In some instances, the verifying includes analyzing reports of undue influence or fraud. The report may be provided by a user who sees content related to the award on a sender's or recipient's profile, e.g., on a third party social networking platform, and selects a link contained in the content to report abuse. In some instances, the verifying includes analyzing a user profile of the award recipient on a social networking platform, e.g., a third party social networking platform. In some instances, analyzing a user profile of the award recipient comprises determining whether the user profile has been active for a predetermined period of time, determining the number of contacts linked to the user profile of the award recipient, and/or analyzing key-words present in posts of the award recipient on the social networking platform. In certain embodiments, the subject methods and social networking systems for rewarding an act that merits an award includes analyzing the pattern of awards received by a recipient. For instance, an award recipient that receives a large number or fraction of awards from first-time users may be flagged for potential abuse of the system.

An implementation of a fraud-detection method is described as follows. 1) Determine if the user has been previously banned from the site by using one or several of the following, alone or in combination: a. their social media profile ID (e.g., Facebook® ID); b. their email address; c. their IP address; d. cookie set on their machine. If the user has been previously banned, disallow access to the platform by either a. shutting down the platform; b. showing an error alert that notifies them of the disallowance; c. locking up the system; or d. other method that discourages further use of the platform. 2) If the user has not been previously banned or is no longer banned, apply any individual or logical (e.g., AND, OR, XOR) combination of the following detection or classification algorithms to determine if the social media account was created and/or currently being used by a real human being (as opposed to a software or hardware robot), and being used for legitimate purposes (e.g., to recognize someone with an award as opposed to generate awards for the recipient due to fraudulent reasons such as a pay-per-award scheme): a. user needs to have at least X photos and/or posts associated with their timeline (where X is a number equal to or larger than 2, e.g., equal to or larger than 4, equal to or larger than 6, equal to or larger than 10, and the like); b. the user profile needs to have existed at least for Y days (where Y is a number equal to or greater than 2, e.g., equal to or larger than 4, equal to or larger than 6, equal to or larger than 10, and the like); c. at least Z number of friends have posted on the user's timeline (where Z is a number equal or greater than 1, e.g., equal to or larger than 2, equal to or larger than 4, equal to or larger than 8, or equal to or larger than 15); d. at least A number of friends have tagged the user on a photo or timeline post (where A is equal or greater than 1, e.g., equal to or larger than 2, equal to or larger than 4, equal to or larger than 8, or equal to or larger than 15); and e. at least B number of photos and/or posts contains tags to the user (where B is equal or greater than 1, e.g., equal to or larger than 2, equal to or larger than 4, equal to or larger than 8, or equal to or larger than 15). If the profile is identified as being used for legitimate purposes, return to calling process, e.g., continue with sending the award to the recipient. If the profile is not identified as being used for legitimate purposes, the user may not be allowed to use the platform to send awards, take a stand, tag others or share. Any standard integer or matrix mathematical or software function or combination thereof that uses the data associated with the social media profile of the sender or others (e.g., IP address, other cookies) can be used as a detection or classification function to determine whether the account was created and/or is being used for legitimate purposes in recognizing another individual. Suitable methods are described in, e.g., U.S. Pat. No. 8,805,845.

Prompting a user to login to a social media platform may be achieved by any suitable method. In one implementation, the steps may include the following. 1) Identify if the human or software entity (e.g., Google® search engine spider) user of the platform—referred to as user—has already logged in through the use of any of standard algorithms (e.g., cookie, session ID linked to the IP of the user). 2) If the user is not logged in, show a button, link or other UX element that offers the opportunity to login through an existing social media profile (e.g., Facebook®, Twitter®). Social media options include Facebook®, Twitter®, Instagram®, LinkedIn®, Pinterest® or others. 3) When the user selects the button or link or other user interaction element, a process starts that uses the API of the relevant social media platform (e.g., OAuth into Facebook® API) to authorize/identify a particular user of that social media platform. 4) Obtain data including at least one of the following: a. name; b. location; c. email address; d. date of birth; e. list of posts made on their timeline including time of posting and content of each posting; f. list of photos posted on their account including time of posting and content g. list of friends and any information associated with them that can be obtained; h. websites associated with the user; i. digital IDs (e.g., Facebook® ID) that identifies them in each social media platform; and j. profile images. In some cases, the user may be able to login using a government or privately issued identification (e.g., passport #, driver's license) that is either checked manually or electronically against the relevant database. In some cases, the user may be able to login through biometrics (e.g., face recognition through camera, fingerprint reader).

### Systems and Devices

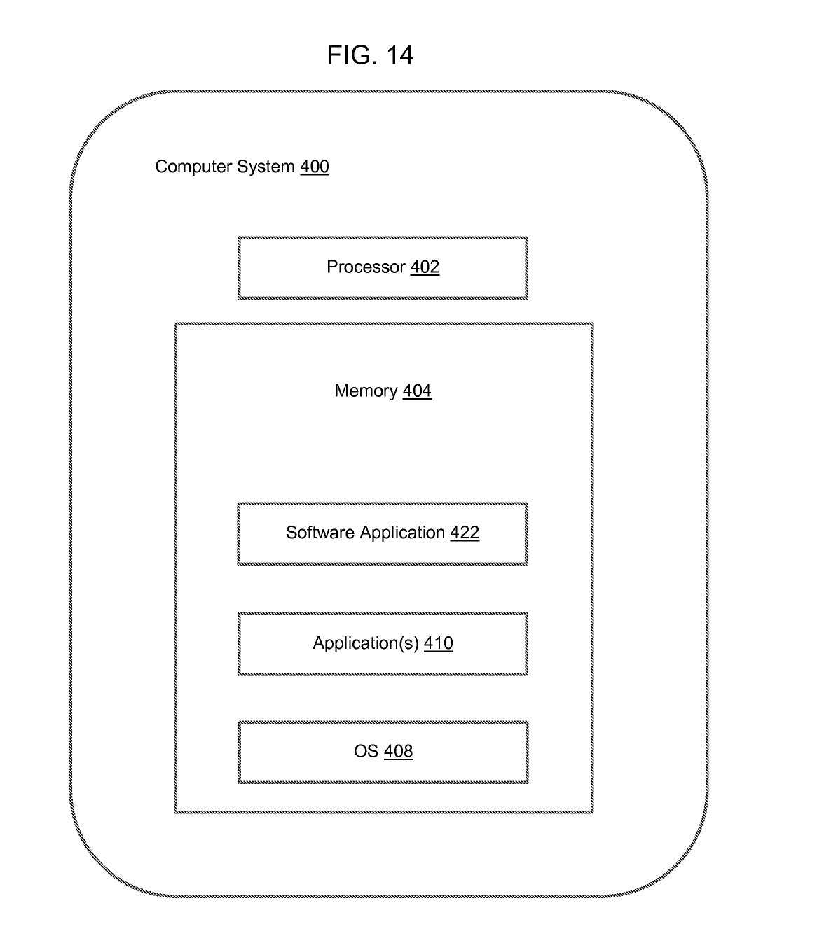

FIG. 14 is a block diagram of the arrangement of components of a computer system 400 configured to provide an interface for an award sender to select an award recipient, create/select an award, send the award and receive notification of receipt of the award, according to an example embodiment. As shown, computer system 400 includes a processor 402 and memory 404, among other components (not shown). In one embodiment, the computer system 400 comprises the sender computer system 112. In another embodiment, the computer system 400 comprises the recipient computer system 122. In certain embodiments, the computer system is a handheld device, e.g., a mobile phone, a smart phone, etc. In certain embodiments, the computer system is a personal computer.

The memory 404 includes various applications that are executed by processor 402, including installed applications 410, an operating system 408, and software application 422. In embodiments where the computer system 400 comprises the sender computer system 402, the software application 422 comprises instructions that when executed cause the computer system to perform the subject methods, as described above.

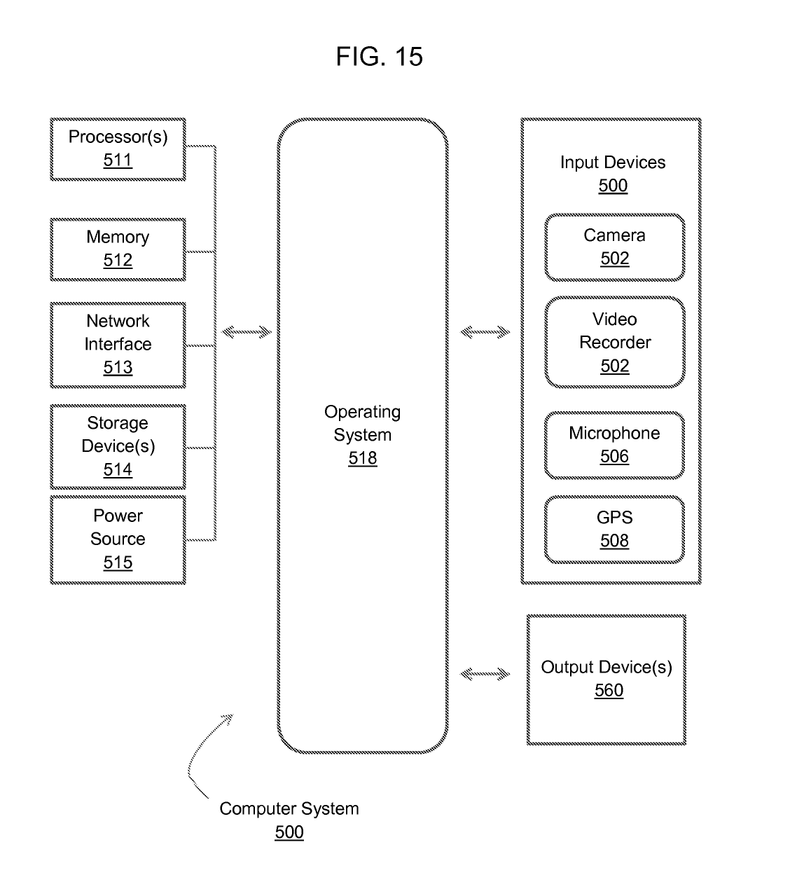

FIG. 15 is a block diagram of example functional components for a computer system 500, according to one embodiment. One particular example of computer system 500 is illustrated. Many other embodiments of the computer system 500 may be used. In one embodiment, the computer system 500 comprises the sender computer system 112. In another embodiment, the computer system 500 comprises the recipient computer system 122.

In the illustrated embodiment of FIG. 15, the computer system 500 includes one or more processor(s) 511, memory 512, a network interface 513, one or more storage devices 514, a power source 515, output device(s) 560, and input device(s) 580. The computer system 500 also includes an operating system 518. Each of components 511, 512, 513, 514, 515, 560, 580, and 518 is interconnected physically, communicatively, and/or operatively for inter-component communications in any operative manner.

As illustrated, processor(s) 511 are configured to implement functionality and/or process instructions for execution within computer system 500. For example, processor(s) 511 execute instructions stored in memory 512 or instructions stored on storage devices 514. Memory 512, which may be a non-transitory, computer-readable storage medium, is configured to store information within computer system 500 during operation. In some embodiments, memory 512 includes a temporary memory, area for information not to be maintained when the computer system 500 is turned OFF. Examples of such temporary memory include volatile memories such as random access memories (RAM), dynamic random access memories (DRAM), and static random access memories (SRAM). Memory 512 maintains program instructions for execution by the processor(s) 511. In certain embodiments, the non-transitory computer-readable storage medium contains instructions, executable by the processor(s) 511, that when executed cause the computer system 500 to perform the subject methods, as described herein.

Storage devices 514 also include one or more non-transient computer-readable storage media. Storage devices 514 are generally configured to store larger amounts of information than memory 512. Storage devices 514 may further be configured for long-term storage of information. In some examples, storage devices 514 include non-volatile storage elements. Non-limiting examples of non-volatile storage elements include magnetic hard disks, optical discs, floppy discs, flash memories, or forms of electrically programmable memories (EPROM) or electrically erasable and programmable (EEPROM) memories.

The computer system 500 uses network interface 513 to communicate with external devices via one or more networks, such as the provider server 132 shown in FIG. 11. Network interface 513 may be a network interface card, such as an Ethernet card, an optical transceiver, a radio frequency transceiver, or any other type of device that can send and receive information. Other non-limiting examples of network interfaces include wireless network interfaces, e.g., Bluetooth®, 4G and WiFi® radios in mobile computer system s, and USB (Universal Serial Bus). In some embodiments, the computer system 500 uses network interface 513 to wirelessly communicate with an external device, a mobile phone of another, or other networked computer system.

Wireless networks as described herein may include, but are not limited to, Code Divisional Multiple Access (CDMA) networks, the Group Special Mobile or the Global System for Mobile Communications (GSM) and the General Packet Radio Service (GPRS) networks, third-generation (3G) networks such as Enhanced Data-rates for Global Evolution (EDGE) and Universal Mobile Telecommunications Systems (UMTS), fourth-generation (4G) networks such as Mobile WiMax and Long Term Evolution (LTE), International Mobile Telecommunications-Advanced (IMT-Advanced) networks, and future fifth-generation (5G) networks exceeding the capabilities of the current 4G/IMT-Advanced standards. Examples of wireless networks include, for example, a BLUETOOTH network, a wireless personal area network, a wireless 802.11 local area network (LAN), and/or wireless telephony network (e.g., a cellular, PCS, or GSM network).

The computer system 500 includes one or more input devices 580. Input devices 580 are configured to receive input from a user through tactile, audio, video, or other sensing feedback. Non-limiting examples of input devices 580 include a presence-sensitive screen, a mouse, a keyboard, a voice responsive system, camera 502, a video recorder 504, a microphone 506, a GPS module 508, or any other type of device for detecting a command from a user or sensing the environment. In some examples, a presence-sensitive screen includes a touch-sensitive screen. One or more output devices 560 are also included in computer system 500. Output devices 560 are configured to provide output to a user using tactile, audio, and/or video stimuli. Output devices 560 may include a display screen (part of the presence-sensitive screen), a sound card, a video graphics adapter card, or any other type of device for converting a signal into an appropriate form understandable to humans or machines. Additional examples of output device 360 include a speaker, a cathode ray tube (CRT) monitor, a liquid crystal display (LCD), or any other type of device that can generate intelligible output to a user. In some embodiments, a device may act as both an input device and an output device.

The computer system 500 includes one or more power sources 515 to provide power to the computer system 300. Non-limiting examples of power source 515 include single-use power sources, rechargeable power sources, and/or power sources developed from nickel-cadmium, lithium-ion, or other suitable material. The computer system 500 includes an operating system 518, such as a Windows®, Apple® OS, iOS®, or Android® operating system. The operating system 518 controls operations of the components of the computer system 500. For example, the operating system 518 facilitates the interaction among processors 511, memory 512, network interface 513, storage device(s) 514, input device 580, output device 560, and power source 515.

All publications and patent applications cited in this specification are herein incorporated by reference as if each individual publication or patent application were specifically and individually indicated to be incorporated by reference. The citation of any publication is for its disclosure prior to the filing date and should not be construed as an admission that the present invention is not entitled to antedate such publication by virtue of prior invention.

1. A computer-implemented method for rewarding an act, the method comprising:
i) providing an award sender with a user interface on a computer system which allows the award sender to select an award recipient;
ii) providing the award sender with an option to create an award and/or select an award from a preexisting award template using the user interface, wherein the award comprises an award category;
iii) sending an award sender-created award and/or award sender-selected award to the award recipient based on the award sender's selection of the award recipient for having performed an act that merits an award; and
iv) posting content regarding the award received by the recipient on a communally accessible online platform.

2. The method of claim 1, wherein the user interface displays a selectable list of individuals obtained from a user profile of the award sender on a third party social network, thereby allowing the award sender to select an award recipient.

3. The method of claim 1, wherein the user interface provides for the identification and/or selection of a funding recipient and the content comprises a link to a third-party online platform or social network profile associated with the funding recipient.

4. The method of claim 1, wherein the communally accessible online platform comprises a social networking platform, a provider website and/or a third party website.

5. The method of claim 1, wherein the method comprises verifying that the award recipient has received the award before the posting step.

6. The method of claim 5, wherein the verifying comprises:
providing an acknowledgement link in the award for a user to acknowledge themselves as the recipient;
prompting the user to grant access to a social network profile associated with the user upon the user selecting the acknowledgement link;
identifying the award sender in the social network profile associated with the user, thereby verifying that the award recipient has received the award.

7. The method of claim 1, wherein the method comprises before step iv), receiving an authorization from the award recipient to publicly display the content regarding the award, and wherein the posted content is publicly viewable.

8. The method of claim 1, wherein the content comprises one or more of:
an image and/or text of the award comprising an identifier for the recipient and the award category;
a description of the award;
a link for a user to acknowledge themselves as the recipient.
a link to the award;
a link to take a stand for or request a role in the act for which the award was received;
a link to tag others or publicize the award through third party social networking platforms;
a link to report abuse;
a link to one or more third party websites; and
a link to donate or contribute resources to a funding recipient.

9. The method of claim 8, wherein the image and/or text of the award is tagged to the recipient's profile on a social network and/or the profile of the funding recipient on a social network.

10. The method of claim 1, wherein the award comprises an image and/or text comprising a description of the category of award and/or a dedication text and/or virtual credits.

11. The method of claim 1, wherein the method further comprises maintaining a first user profile of the award sender, wherein the first user profile is linked to a second user profile of the award sender on a third-party social networking platform and wherein the first user profile comprises a record of awards sent by the sender.

12. The method of claim 11, wherein the first user profile comprises a record of the awards for which the sender has taken a stand.

13. The method of claim 1, wherein the method further comprises maintaining a user profile of the award recipient, wherein the user profile comprises a record of awards received by the recipient.

14. The method of claim 13, wherein the user profile comprises a record of the awards for which the recipient has taken a stand.

15. The method of claim 13, wherein the method further comprises displaying a visual representation of the record of the awards received by the award recipient.

16. The method of claim 13, wherein the sending comprises sending a message that the award recipient has received a third-party award, triggered when the recipient has accumulated a number of awards above a predetermined threshold.

17. The method of claim 1, wherein the method further comprises generating a list of a plurality of award recipients ranked according to the number and/or category of awards received by each award recipient.

18. The method of claim 1, wherein the identity of the sender is not provided to the award recipient.

19. The method of claim 1, wherein the sending step comprises:
verifying that the sender's selecting the award recipient is not performed as a result of undue influence or fraud; and
sending the award to the award recipient upon the verification.

20. The method of claim 19, wherein the verifying comprises analyzing reports of undue influence or fraud.

21. The method of claim 19, wherein the verifying comprises analyzing a user profile of the award recipient on a social networking platform.

22. The method of claim 21, wherein analyzing a user profile of the award recipient comprises determining whether the user profile has been active for a predetermined period of time.

23. The method of claim 21, wherein analyzing a user profile of the award recipient comprises determining the number of contacts linked to the user profile of the award recipient.

24. The method of claim 21, wherein analyzing a user profile of the award recipient comprises analyzing key-words present in posts of the award recipient on the social networking platform.

25. The method of claim 1, wherein the method comprises:
a) providing an award sender with an account with a first amount of virtual credits that determines the number of awards that can be sent to a recipient; and
b) sending an award to the award recipient and deducting a second amount of virtual credits from the sender's account upon the sender selecting the award recipient for having performed an act that merits an award.

26. The method of claim 25, wherein the virtual credits are time-restricted credits.

27. The method of claim 26, wherein the value of the virtual credits decays in a time-dependent manner.

28. The method of claim 26, wherein the virtual credits expire following a predetermined time period.

29. The method of claim 26, wherein the virtual credits are conditionally time-restricted credits, wherein the time dependence is reset upon the sender successfully rewarding the award recipient.

30. The method of claim 25, wherein the method comprises adding a third amount of virtual credits to an account for the recipient.

31. The method of claim 30, wherein the method comprises adding a fourth amount of virtual credits to the sender's account at a time interval.

32. The method of claim 1, wherein the method comprises notifying the award sender that the award recipient has been rewarded upon the award recipient receiving the award.

33. The method of claim 3, wherein the method comprises sending funds to the funding recipient upon the sender selecting the award recipient for having performed the act that merits the award.

34. The method of claim 1, wherein the computer system is a handheld device.

35. A non-transitory computer-readable storage medium for rewarding an act, comprising:
instructions, executable by at least one processing device, that when executed cause the processing device to perform the method of claim 1.

36. A computer-implemented method comprising generating an aspirational fingerprint based on a category and/or content of an award created and/or selected by an award sender in the method of claim 1.

37. A computer-implemented method comprising generating an aspirational fingerprint based on the identity and/or subject matter associated with a funding recipient identified and/or selected in connection with claim 3.

38. A computer-implemented method of utilizing a personalized behavior profile of an individual, comprising:
linking to an individual's electronically stored aspirational fingerprint upon the individual accessing a webpage and/or clicking on an item displayed on the webpage;
selecting content to display to the individual based on their aspirational fingerprint; and
displaying the selected content to the individual.

39. The method of claim 38, comprising updating the individual's aspirational fingerprint based on one or more actions taken by the user in response to the displayed content.

40. The method of claim 39, wherein the one or more actions, comprises a click-through event.

41. A non-transitory computer-readable storage medium, comprising:
instructions, executable by at least one processing device, that when executed cause the processing device to perform the method of claim 38.

42. A computer-implemented method of utilizing a personalized behavior profile of an individual, comprising:
receiving identifying information from an individual at a brick and mortar location;
linking to an individual's electronically stored aspirational fingerprint associated with the identifying information;
selecting content to display to the individual based on their aspirational fingerprint; and
displaying the selected content to the individual.

43. The method of claim 42, comprising updating the individual's aspirational fingerprint based on one or more actions taken by the user in response to the displayed content.

44. A non-transitory computer-readable storage medium, comprising:
instructions, executable by at least one processing device, that when executed cause the processing device to perform one or more of the steps of claim 42.
